(19) United States
(12) Patent Application Publication
(10) Pub. No.: US 2011/0126018 A1
(43) Pub. Date: May 26, 2011

(54) Methods and systems for transaction digital watermarking in content delivery network

(76) Inventors: Anees Narsinh, Pacific Palisades, CA (US); Jeffrey Lynn Turner, Beverly Hills, CA (US)

(21) Appl. No.: 12/592,309

(22) Filed: Nov. 23, 2009

(51) Int. Cl. H04L 9/32

(52) U.S. Cl. 713/176

(57) ABSTRACT

Methods and systems for applying a transaction digital watermark to content being downloaded over a content delivery network. The digital watermark carries information about the transaction pursuant to which the content was downloaded, which can be useful in establishing a “chain of custody” that facilitates piracy detection and/or other tracking and monitoring applications. Moreover, the digital watermark is applied by an edge caching server, which enables downstream entities in the content delivery chain, such as Internet service providers, to influence the information carried in the digital watermark and enables transaction details that become known after the content leaves the content provider network to be carried in the digital watermark, but without opening up a security hole at the end user premises.

### BACKGROUND OF THE INVENTION

The present invention relates to digital watermarking and, more particularly, methods and systems for applying a digital watermark to digital content being downloaded over a content delivery network (CDN).

CDNs are a preferred vehicle for distributing entertainment content, such as movies, music and video games, over the Internet. A CDN is a specialized type of content distribution network wherein a system of edge caching servers store content at various points in the network so as to facilitate access to the content by end user devices throughout the network. Where available, an end user device downloads the content from an edge caching server local to the end user device, rather than from a centralized origin server in the content provider network.

Meanwhile, a digital watermark is a marking embedded in digital content that is typically imperceptible in the content as viewed or played but detectable by appropriate watermark reading or content tracking software, and that persists on copies made of the digital content.

To help prevent Internet piracy, it is known to apply to entertainment content distributed on digital video discs (DVDs) digital watermarks that carry intellectual property rights (IPR) and content producer information. These digital watermarks are applied to DVDs prior to making the DVDs commercially available, and typically carry copyright information for the content, such as author, owner, and/or usage restrictions. End users who receive a DVD having a digital watermark can use watermark reading software to learn this information.

It has also been suggested in networks other than CDNs to have content providers apply to downloaded content digital watermarks having IPR, content producer and transaction information. These watermarks are applied before the content is downloaded from the content provider's server. Because these watermarks are not applied more locally to the end user devices that receive the downloaded content, the transaction information available for application to these watermarks is limited. These watermarks cannot carry transaction details that may become known after the content leaves the content provider's server, such as information about the download path, download quality, or quality of experience. Moreover, downstream entities in the content delivery chain, such as Internet Service Providers (ISPs), cannot influence the information carried in these watermarks.

Additionally, some digital television networks are known to apply digital watermarks to television streams at the end user premises. However, the transaction information carried in these watermarks is limited, and reliance on end user equipment (e.g. set-top boxes) for application of these watermarks raises security concerns. For example, an end user having sufficient technical expertise could potentially disable the digital watermarking function.

### SUMMARY OF THE INVENTION

The present invention, in a basic feature, provides methods and systems for applying a transaction digital watermark to content being downloaded over a CDN. The digital watermark carries information about the transaction pursuant to which the content was downloaded, which can be useful in establishing a “chain of custody” that facilitates piracy detection and/or other tracking and monitoring applications. Moreover, the digital watermark is applied by an edge caching server, which enables downstream entities in the content delivery chain, such as ISPs, to influence the information carried in the digital watermark and enables transaction details that become known after the content leaves the content provider network to be carried in the digital watermark, but without opening up a security hole at the end user premises.

In one aspect of the invention, a CDN comprises an origin server, a transaction processing system and an edge caching server communicatively coupled with origin server and the transaction processing system, wherein the edge caching server applies to content received from the origin server a digital watermark carrying download transaction details received at least in part from the transaction processing system and transmits the content having the digital watermark to an end user device.

In some embodiments, the transaction processing system transmits download transaction details to the edge caching server in response to approving a download transaction with an end user using information received from the end user device.

In some embodiments, the transaction processing system transmits download transaction details to the edge caching server in further response to selecting the edge caching server from among a plurality of edge caching servers based at least in part on network location of the edge caching server.

In some embodiments, the edge caching server decodes the content and applies the digital watermark to the decoded content.

In some embodiments, the edge caching server verifies a steganographically usable area within the decoded content and applies the digital watermark to the steganographically usable area.

In some embodiments, the download transaction details include end user identification information, such as end user name, end user number, end user mailing address, end user email address or end user phone number.

In some embodiments, the download transaction details include Internet access information, such as an identifier of the end user's ISP or the Internet Protocol (IP) or Media Access Control (MAC) address of the end user device.

In some embodiments, the download transaction details include payment information, such as a license fee paid.

In some embodiments, the download transaction details include time information, such as transaction date or time of day.

In some embodiments, the download transaction details include download path information, such as IP or MAC addresses of one or more network nodes in the download path.

In some embodiments, the download transaction details include download quality information, such as transmission rate, delay, jitter, packet drop probability and bit error rate.

In some embodiments, the download transaction details include a unique transaction identifier.

In some embodiments, the content comprises a prerecorded content file.

In some embodiments, the content comprises a live content stream.

In another aspect of the invention, an edge caching server for a CDN comprises one or more network interfaces, a memory and a processor communicatively coupled with the network interfaces and the memory, wherein under control of the processor the edge caching server applies a digital watermark carrying download transaction details to content received on one of the network interfaces and transmits the content on one of the network interfaces.

In yet another aspect of the invention, a method for digital watermarking comprises the steps of receiving content on an edge caching server, applying by the edge caching server to the content a digital watermark carrying download transaction details and transmitting the content from the edge caching server.

These and other aspects will be better understood by reference to the following detailed description taken in conjunction with the drawings that are briefly described below.

### BRIEF DESCRIPTION OF THE DRAWINGS

FIG. 1 shows a CDN in some embodiments of the invention.

FIG. 2 shows a representative edge caching server in more detail.

FIG. 3 shows elements of an edge caching server stored in memory.

FIG. 4 shows a method for digital watermarking performed by an edge caching server.

### DETAILED DESCRIPTION OF A PREFERRED EMBODIMENT

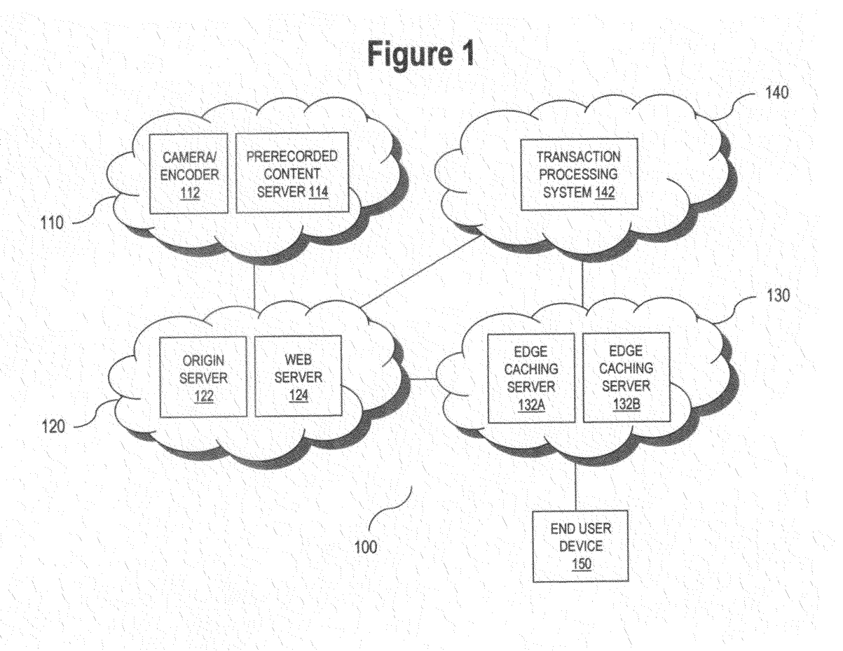

In FIG. 1, a CDN 100 is shown in some embodiments of the invention. CDN 100 includes a content producer network 110, a content provider network 120, an ISP network 130 and a transaction management network 140. Content producer network 110 has a camera/encoder 112 and a prerecorded content server 114. Content provider network 120 has an origin server 122 and a Web server 124. ISP network 130 has edge caching servers 132A, 132B. Transaction processing network 140 has a transaction processing system 142.

Camera/encoder 112 is a network element that captures live content, such as live video and audio content, digitally encodes the live content and delivers content streams having the live content to origin server 122, which makes the content streams available for download.

Prerecorded content server 114 is a network element that is a source for prerecorded content, such as prerecorded video and audio content, and delivers copies of content files having the prerecorded content to origin server 122, which makes the content files available for download.

Origin server 122 is a network element that is a source for content and fulfills requests for content made by edge caching servers (e.g. 132A, 132B). Upon receiving a request for content from an edge caching server, origin server 122 delivers the requested content to the requesting edge caching server. For example, where the requested content is prerecorded content, origin server 122 makes a copy of a content file having the prerecorded content and transmits the copy to the requesting edge caching server. Requested content may include, for example, movies, music, video games, live and prerecorded broadcast television and radio programs, live and prerecorded non-broadcast video and audio programs (e.g. YouTube videos, Podcasts etc.). In some embodiments, requested content may include documents (e.g. copyrighted publications, confidential business plans, etc.).

Web server 124 is a network element that hosts a content provider website and redirects to transaction processing system 142 download transaction requests made on the website by end user devices (e.g. 150). Web server 124 renders Web pages from the content provider website to end user devices that have contacted the website. Upon receiving a download transaction request from an end user device, Web server 124 redirects or otherwise offloads the download transaction request to transaction processing system 142.

Edge caching servers 132A, 132B are network elements that fulfill requests for content made by end user devices (e.g. 150) upon designation by transaction processing system 142. Upon receiving from transaction processing system 142 notice of designation to fulfill a request, an edge caching server determines whether the requested content is already available on the edge caching server as a result of an earlier request. For example, where the requested content is prerecorded content, edge caching server determines whether a content file having the prerecorded content s locally cached as a result of previous download from origin server 122 and, if not, retrieves the content file from origin server 122 and caches the content locally. The designated edge caching server then makes a copy of the content file and applies to the copy a digital watermark carrying transaction details received at least in part from transaction processing system 142. The designated edge caching server transmits the copy of the content file to the requesting end user device.

Transaction processing system 142 is a network element that regulates a transaction in which content is downloaded to an end user device (e.g. 150). Transaction processing system 142 receives from an end user device a request for download of content, processes and approves or denies the request, and designates an edge caching server (e.g. 132A) to fulfill the request if approved. Request processing includes verifying end user and payment information provided by an end user device and notifying an end user device as to whether the request has been approved or denied. Edge caching server designation includes selecting an edge caching server from a plurality of edge caching servers for delivering the content to the end user device, notifying the selected edge caching server of the designation and transmitting details of the transaction to the selected edge caching server. Selection criteria may include, for example, the proximity of (e.g. number of hops between) the edge caching server and the end user device and/or the edge caching server's current workload. The proximity of an edge caching server to an end user device may be determined by a location resolution service integral or accessible to transaction processing system 142. The current workload of an edge caching server may be determined by polling of the edge caching server or other means, such as estimation based on past designations.

End user device 150 is a network element operated by an end user and having content playing capability, such as a personal computer (PC), personal data assistant (PDA), smart phone or media player. End user device 150 contacts a website hosted on Web server 124 via an Internet connection, such as a digital subscriber line (DSL), cable modem, 802.11 (WiFi) or 802.16 (WiMAX) connection and requests download of content. End user device 150 is redirected to transaction processing system 142 and provides to transaction processing system 142 end user identity, contact and payment information required by transaction processing system 142 in order to evaluate the request. End user device 150 also stores and, at user discretion, plays or displays content from a content stream or file downloaded in fulfillment of the request, if the request is approved.

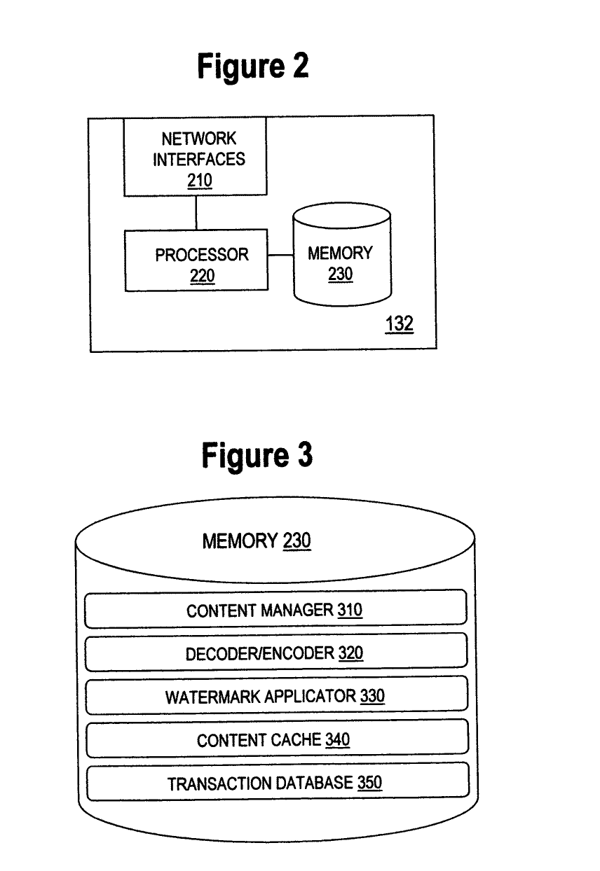

Turning to FIG. 2, an edge caching server 132, which is representative of edge caching servers 132A, 1326, is shown in some embodiments. Edge caching server 132 has one or more network interfaces 210 and a memory 230, which are communicatively coupled with a processor 220. Turning to FIG. 3, memory 230 is shown in some embodiments to retain software executable by processor 220 including a content manager 310, an encoder/decoder 320 and a watermark applicator 330. Memory 240 is also shown to include a content cache 340 and a transaction database 350.

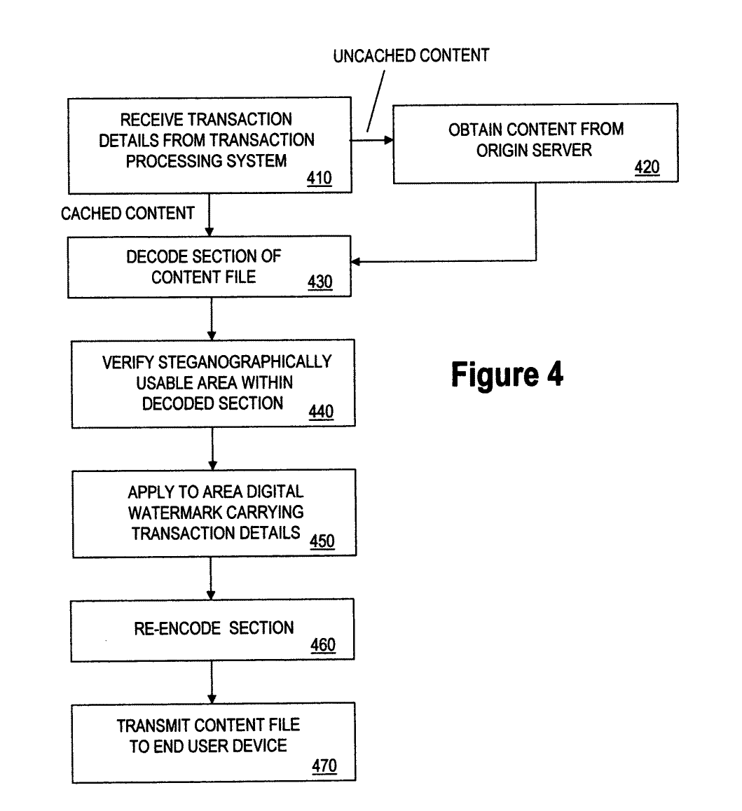

FIG. 4 shows a method for digital watermarking performed by edge caching server 130 under control of processor 220 in some embodiments. In the illustrated method, a content file having prerecorded content is requested, although in other embodiments a live content stream or a document may be requested. After being designated by transaction processing system 142 to fulfill a content request initiated by end user device 150, content manager 310 receives from transaction processing system 142 details of the download transaction (410).

Content manager 310 next determines whether the content to be downloaded is locally stored in content cache 340. If the content is not locally stored in content cache 340, content manager 310 downloads from origin server 122 a content file having the content (420) and stores the content in content cache 340. Content manager 310 also makes a copy of the content file for use in fulfillment of the request.

Decoder/encoder 320 then decodes a section of the content file (430). Decoder/encoder 320 may decrypt and decompress the section of the content file as part of decoding. Decoder/encoder 320 selects for decoding a section of the content file that is presumed to have prerecorded content to be played or viewed, as opposed to file metadata.

Watermark applicator 330 then verifies a steganographically usable area within the decoded section of the content file (440). A steganographically usable area is a region of the content perceptible to the user when played or viewed that has sufficiently high potential for carrying a digital watermark that is imperceptible by a user when the region is played or viewed. For example, a region of video content that when played renders a uniform black screen is not steganographically usable, since even careful modification of the RGB bitmap in that region might be visually detectable by a user who is viewing. On the other hand, a region of video content that when played renders a diverse multicolored screen is steganographically usable since careful modification of the RGB bitmap in that region would go unnoticed by a viewer who is viewing.

Watermark applicator 330 next applies to the steganographically usable area a digital watermark carrying transaction details (450). For example, for video content, watermark applicator 330 may apply the digital watermark by changing the least significant bit for each color of a sufficient number of RGB pixels to carry the transaction details.

Download transaction details applied as a digital watermark by content delivery device 130 may include, by way of example, end user identification information, such as a end user name, end user subscriber number, end user mailing address, end user email address or end user phone number; Internet access information, such as an identifier of the end user's ISP or the IP or MAC address of end user device 150; payment information, such as license fee paid; timing information, such as transaction date or time of day; routing information, such as IP or MAC addresses of network nodes in the download path; download quality information, such as transmission rate, delay, jitter, packet drop probability and bit error rate; and/or a unique transaction identifier. A digital watermark applied by edge caching server 142 may carry transaction details received from transaction processing system 142 or from another external source, and may additionally or alternatively carry transaction details generated internally on edge caching server 132.

After application of the digital watermark, decoder/encoder 320 re-encodes the section of the content file (460). Decoder/encoder 320 may encrypt and compress the section of the content file as part of re-encoding.

Content manager 310 then downloads to end user device 150 the content file having the digital watermark carrying the download transaction details (470). Content manager 310 may also create and store in transaction database 350 a record of the download transaction. The contents of transaction database 350 may be periodically or episodically uploaded to transaction processing system 142 for analysis.

It will be appreciated by those of ordinary skill in the art that the invention can be embodied in other specific forms without departing from the spirit or essential character hereof. By way of example, in some embodiments a non-steganographic digital watermark may be applied to content, which obviates the need to verify a steganographically usable area. The present description is therefore considered in all respects to be illustrative and not restrictive.

What is claimed is:

1. A content delivery network, comprising:
an origin server;
a transaction processing system; and
an edge caching server communicatively coupled with origin server and the transaction processing system, wherein the edge caching server applies to content received from the origin server a digital watermark carrying download transaction details received at least in part from the transaction processing system and transmits the content having the digital watermark to an end user device.

2. The content delivery network of claim 1, wherein the transaction processing system transmits download transaction details to the edge caching server in response to approving a download transaction with an end user using information received from the end user device.

3. The content delivery network of claim 2, wherein the transaction processing system transmits download transaction details to the edge caching server in further response to selecting the edge caching server from among a plurality of edge caching servers based at least in part on network location of the edge caching server.

4. The content delivery network of claim 1, wherein the edge caching server decodes the content and applies the digital watermark to the decoded content.

5. The content delivery network of claim 4, wherein the edge caching server verifies a steganographically usable area within the decoded content and applies the digital watermark to the steganographically usable area.

6. The content delivery network of claim 1, wherein the download transaction details include end user identification information.

7. The content delivery network of claim 1, wherein the download transaction details include Internet access information.

8. The content delivery network of claim 1, wherein the download transaction details include payment information.

9. The content delivery network of claim 1, wherein the download transaction details include time information.

10. The content delivery network of claim 1, wherein the download transaction details include download path information.

11. The content delivery network of claim 1, wherein the download transaction details include download quality information.

12. The content delivery network of claim 1, wherein the download transaction details include a unique transaction identifier.

13. The content delivery network of claim 1, wherein the content comprises a prerecorded content file.

14. The content delivery network of claim 1, wherein the content comprises a live content stream.

15. An edge caching server for a content delivery network, comprising:
one or more network interfaces;
a memory; and
a processor communicatively coupled with the network interfaces and the memory, wherein under control of the processor the edge caching server applies a digital watermark carrying download transaction details to content received on one of the network interfaces and transmits the content on one of the network interfaces.

16. The edge caching server of claim 15, wherein the edge caching server decodes the content and applies the digital watermark to the decoded content.

17. The edge caching server of claim 16, wherein the edge caching server verifies a steganographically usable area within the decoded content and applies the digital watermark to the steganographically usable area.

18. The edge caching server of claim 15, wherein the download transaction details include end user identification information.

19. The edge caching server of claim 15, wherein the download transaction details include Internet access information.

20. The edge caching server of claim 15, wherein the download transaction details include payment information.

21. The edge caching server of claim 15, wherein the download transaction details include time information.

22. The edge caching server of claim 15, wherein the download transaction details include download path information.

23. The edge caching server of claim 15, wherein the download transaction details include download quality information.

24. The edge caching server of claim 15, wherein the download transaction details include a unique transaction identifier.

25. The edge caching server of claim 15, wherein the content comprises a prerecorded content file.

26. The edge caching server of claim 15, wherein the content comprises a live content stream.

27. A method for digital watermarking, comprising the steps of:
receiving content on an edge caching server;
applying by the edge caching server to the content a digital watermark carrying download transaction details; and
transmitting the content from the edge caching server.

28. The method of claim 27, further comprising the steps of:
decoding the content; and
verifying a steganographically usable area within the decoded content, wherein the digital watermark is applied to the steganographically usable area.

29. The method of claim 27, wherein the download transaction details include end user identification information.

30. The method of claim 27, wherein the download transaction details include Internet access information.

31. The method of claim 27, wherein the download transaction details include payment information.

32. The method of claim 27, wherein the download transaction details include time information.

33. The method of claim 27, wherein the download transaction details include download path information.

34. The method of claim 27, wherein the download transaction details include download quality information.

35. The method of claim 27, wherein the download transaction details include a unique transaction identifier.

36. The method of claim 27, wherein the content comprises a prerecorded content file.

37. The method of claim 27, wherein the content comprises a live content stream.
